(19) United States
(12) Patent Application Publication
(10) Pub. No.: US 2003/0232694 A1
(43) Pub. Date: Dec. 18, 2003

(54) Planetary gear train

(75) Inventor: Frank Buhrke, Weinheim (DE)

Correspondence Address: Joel S. Carter, Patent Department, DEERE & COMPANY, One John Deere Place, Moline, IL, 61265-8098, US

(73) Assignee: Deere & Company, a Delaware Corporation

(21) Appl. No.: 10/424,403

(22) Filed: Apr. 28, 2003

(30) Foreign Application Priority Data
Jun. 15, 2002 (DE) 102 26 796.0

(51) Int. Cl. F16H 57/08

(52) U.S. Cl. 475/346

(57) ABSTRACT

A planetary gear train includes a sun gear, a planet carrier, and a plurality of planet gears, which are rotatably mounted on the planet carrier. The gear train may also include a ring gear or housing surrounding the planet gears. Space filling members are mounted in the spaces between adjacent planet gears, the sun gear, and, if necessary, the ring gear or the housing. These space filling members extend axially from the planet carrier and are spaced apart from the gears by a gap having a uniform thickness.

### BACKGROUND

The invention relates to a planetary gear train, which includes a sun gear, a planet carrier and a plurality of planet gears rotatably mounted on the planet carrier.

Planetary gear trains, particularly friction wheels and toothed-gear planetary gear trains, are used in many fields of power and powered technology, such as motor vehicles, where a high transmission ratio and a compact assembly is required. Thus, it is desirable with such planetary gear trains to achieve as high an efficiency as possible. In general, planetary gear trains have a sun gear that is connected to a drive shaft and planet gears which are carried by a planet carrier and which roll on the sun gear. Different numbers of planet gears may be arranged uniformly around the sun gear. A ring gear surrounds and engages the ring gear. The planet gears are each mounted on a shaft so that they can rotate and these shafts are rigidly connected to the planet carrier. The planet carrier can have a single-support frame, i.e., the planet shafts are held by the planet carrier on one side, or a multi-support frame, i.e., the planet shafts are held by the planet carrier at several points. Planet pins or planet bolts are used as shafts for holding and bearing the planets.

Such a configuration of a planetary gear train with single support-frame planetary carrier is disclosed in WO 01/35004 A1. This type of friction wheel or toothed-gear arrangement produces a plurality of torque and rpm transmission ratios. Thus, the driven system can be coupled to the ring gear or to the planetary carrier. Additional possibilities and variations with reference to drive and driven systems with planetary gear trains are known and described, e.g., in “Dubbel, Taschenbuch für Maschinenbau [Handbook for Mechanical Engineering].”

In order to achieve as high as possible a gear efficiency, the frictional losses must be kept to a minimum in such a planetary gear train. Thus, the gear housing is filled with gear oil, so that the gears run in an oil bath. A planetary gear train has the disadvantage that the rotation of the planetary carrier and the planets about the sun gear produces considerable slip losses and foaming of the gear oil. This generates, in turn, an undesired increase in the oil temperature. Slip losses cause reduced gear efficiency.

### SUMMARY

Accordingly, an object of this invention is to provide a planetary gear train of the type mentioned above, which can overcome the previously mentioned problems.

A further object of the invention is to provide an efficiency-optimized planetary gear train, which reduces the slip losses resulting from the rotation of the planet carrier and the planets and prevents foaming of the gear oil.

A further object of the invention is to provide a planetary gear train which reduces the heat energy dissipated to the gear oil during the rolling of the gears.

These and other objects are achieved by the present invention, wherein planetary gear train has a planetary carrier with self-supporting members. The members extend in the axial direction and essentially fill intermediate spaces resulting between adjacent planet gears, the sun gear, and, if necessary, the ring gear or housing, so that there is no contact between the members and the gears. Filling the intermediate spaces with such members significantly reduces turbulent flow areas, which are generated by the rolling of the gears and by the associated immersion of the rotating gears and planetary carrier in the gear oil bath. The configured members provide for a guided, shallow immersion of the planets in the gear oil bath and prevent the planets from “striking” on the surface of the gear oil bath and the gear oil bath from foaming. This optimizes the efficiency of the planetary gear train by reducing the slip loss. Because eddies in the gear oil are considerably reduced and the oil essentially moves only in predetermined tracks in the intermediate spaces, less heat energy is generated, so that the oil temperatures are lower.

Such members can be used both in friction wheel and also in toothed-gear planetary gear trains or also in other epicyclical gear systems, in which planets mounted on planet shafts orbit a center point. The members can consist of a relatively soft or low-strength material, because the members are formed self-supporting and are not used for a load-bearing or force-transferring function.

In a preferred configuration of the invention, a member essentially has the contour and volume of an intermediate space, such that essentially constant spacers are formed between the member and the gears surrounding the member. The spacers are dimensioned such that along the cylindrically curved envelope surface of each gear (sun gear, planet gear, and ring gear) there is preferably as small and constant as possible a distance to the surfaces of the members, wherein the surfaces of the members likewise have cylindrically curved envelope surfaces and correspond to the envelope surfaces of the gears, so that the contour of the members is essentially fitted to the geometry of the gears. Thus, the smaller the spacers, the larger the filled volume of the intermediate spaces and the smaller the slip losses in the planetary gear train. Here, it should be noted that a configuration of the planetary gear train with larger spacers can also be advantageous, i.e., intermediate spaces that are not significantly filled also produce a reduction of the slip losses and thus an optimization of the gear efficiency.

In another preferred configuration of the invention, the planet carrier and the members are manufactured from one part, e.g., cast in one piece. The one-piece configuration is advantageous because no assembly of the members on the planet carrier is required and the production costs can be reduced.

In an alternative configuration of the invention, the members are formed separately and attached to the planet carrier. The members can be attached to the planet carrier by screws, alignment pins, seams, welds, or other connections. The advantage of this solution is that the planet carrier and the members can consist of different materials and a less rigid and lighter material can be used for the members.

In an especially preferred configuration of the invention for preferably single support-frame planet carriers, a sealing plate is on the end surfaces of the members opposite the planet carrier. The sealing plate covers the members and the planet gears. Covering the planet gears with the sealing plate produces additional optimization of the efficiency, because the rotation of the planets affects the gear oil bath only to a reduced degree. The sealing plate is preferably formed separately and attached to the members or the planet carrier. The sealing plate can be attached to the members or to the planet carrier by screws, alignment pins, seams, welds, or other connections. In an alternative configuration of the invention, the sealing plate and the members are formed preferably in one piece and attached together to the planet carrier, which eliminates the need for attachment means for the sealing plate.

In another preferred configuration of the invention, at least one surface of the members facing the gears and, if necessary, the sealing plate, is profiled. Here, flow tracks are preferably formed in the surface of the members to produce a flow-optimized interaction between the surface and the gear oil. The flow tracks are thus preferably formed on the cylindrically curved outer surface of the members and preferably run in the direction of rotation of the gears. Furthermore, the attachment of other flow-optimizing profiles is conceivable, as in, e.g., a scale pattern or the like.

According to the invention, the members and, if necessary, also the sealing plate, particularly for a separate configuration, preferably consist of a material with low strength and/or density. Because the members and also, if necessary, the sealing plate, transfer no significant forces and/or moments, it is possible to manufacture these components out of a preferably light and relatively soft material. Thus, the members can consist, e.g., of aluminum, heat-resistant plastic (e.g., polyamide), or also carbon fiber. Preferably, such materials have a very low density and thus no significant, additional masses need to be moved.

In an alternative configuration of the invention, the members can be formed as hollow bodies. This can optimize the weight for the use of such members. The hollow bodies are preferably sealed, so that no gear oil can penetrate.

### BRIEF DESCRIPTION OF THE DRAWINGS

FIG. 1 is a schematic front view of a planetary gear train according to the invention with members extending between the planets in the axial direction from a planet carrier;

FIG. 2 is a schematic cross-sectional side view of the planetary gear train of FIG. 1;

FIG. 3 is a perspective view of the schematic member of FIG. 2;

FIG. 4 is a perspective view of a schematic, alternatively configured member with profiled surfaces; and

FIG. 5 is a schematic cross-sectional side view of a planetary gear train in an alternative embodiment with sealing plate.

### DETAILED DESCRIPTION

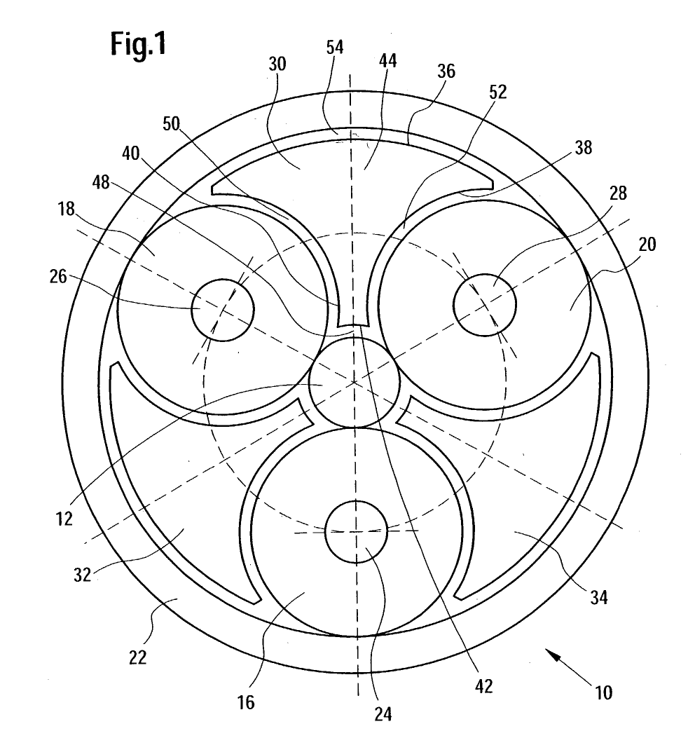

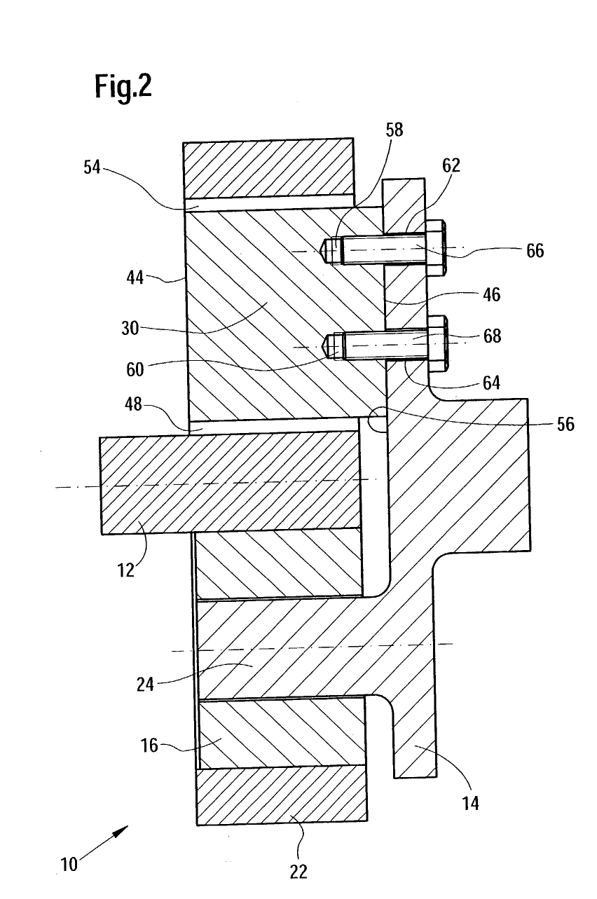

In FIGS. 1 and 2, a toothed-gear planetary gear train 10 is shown schematically, which essentially includes a drive shaft or a sun gear 12, a planet carrier 14 connected to a drive shaft (not shown), planet gears 16, 18, 20, and a ring gear 22 rigidly connected to a housing that is not shown. For simplicity, the teeth of the gears 12, 16, 18, 20, 22 are not shown. The planetary gear train could also be a friction-wheel planetary gear train.

The planetary carrier 14 includes axially extending planet shafts or planet pins 24, 26, 28, which are distributed uniformly around its perimeter, and on which the planet gears 16, 18, 20 are mounted so that they can rotate. The bearing and axial fixing of the planet gears 16, 18, 20 on the planet pins 24, 26, 28 is not shown in more detail. Furthermore, the planet carrier 14 includes projections or members 30, 32, 34, which are distributed uniformly around its perimeter, which extend in the axial direction over the entire width of the planet gears 16, 18, 20, and which are connected rigidly to the planet carrier 14.

The planets 16, 18, 20 are in meshed engagement with the sun gear 12 and the ring gear 22, wherein the planet gears 16,18, 20 circle the sun gear 12 and roll on the inside of the ring gear 22, and thus the planet pins 24, 26, 28 move around the sun gear 12. The rotation of the planet pins 24, 26, 28 sets the planet carrier 14 in rotation.

Due to the arrangement and geometry of the sun gear 12, the planet gears 16,18, 20, and the ring gear 22 relative to each other, an intermediate space is produced between each of the planet gears 16,18, 20, the sun gear 12, and the ring gear 22. The intermediate spaces are filled according to the invention by the members 30, 32, 34.

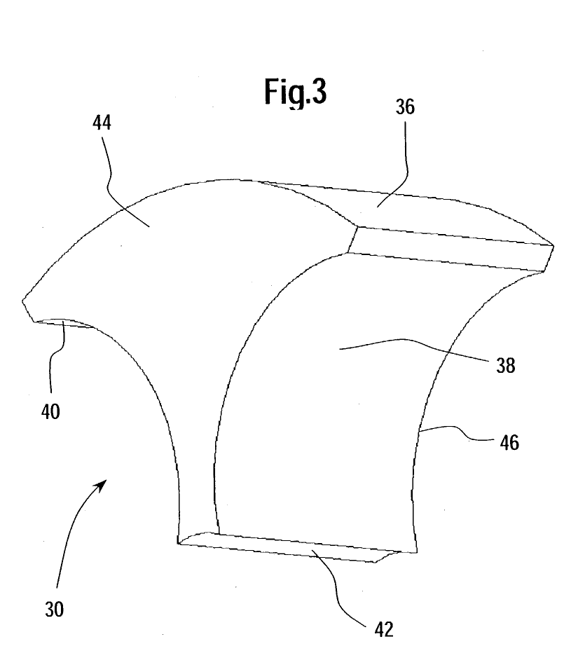

The configuration and geometry of the members 30, 32, 34, i.e., the contour and the volume of each member 30, 32, 34, preferably correspond essentially to the contour and the volume of the intermediate space produced between the planet gears 16, 18, 20, sun gear 12, and ring gear 22. A representative member 30 is shown in detail in FIG. 3. The member 30 has four cylindrically curved surfaces 36, 38, 40, 42 and two flat end surfaces 44, 46. The radii of curvature of the cylindrically curved surfaces 36, 38, 40, 42 match the radii of curvature of the corresponding gears 12, 16, 18, 20, 22. The centers of curvature of the curved surfaces 36, 38, 40, 42 coincide with the axes of rotation of the corresponding gears 12, 16, 18, 20, 22. The radius of the surface 36 essentially corresponds to the inner radius of the ring gear 22, the radius of the surfaces 38 and 40 essentially corresponds to the outer radius of the planet gears 16,18, 20, and the radius of the surface 42 essentially corresponds to the outer radius of the sun gear 12. The size of the members 30, 32, 34 is dimensioned so that between the gears 12, 16, 18, 20, 22 and the cylindrically curved surfaces 36, 38, 40, 42 of the members 30, 32, 34, essentially constant and equally wide spaces 48, 50, 52, 54 are produced, so that the members 30, 32, 34 are self-supporting on the planet carrier 14 without contact to the gears 12, 16, 18, 20, 22. The spacers 48, 50, 52, 54 preferably have a width of a few millimeters in the case of a motor vehicle transmission.

As can be seen from FIG. 2, the member 30 has a free end surfaces 44 which faces away from the planet carrier 14. The other surfaces 46 of the members 30, 32, 34 engages a sealing surface 56 on the planet carrier 14. The members 30, 32, 34 are connected tightly to the planet carrier 14 by bolts 66, 68 which extend though bores 62, 64 in the carrier 14 and are threadably received by threaded holes 58, 60 formed in the members 30, 32, 34.

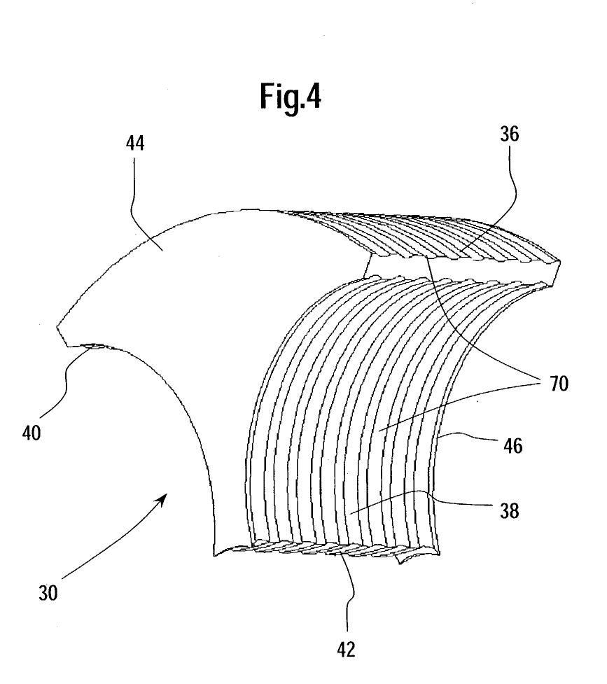

Referring now to FIG. 4, curved surfaces 36, 38, 40, 42 of the members 30, 32, 34 are profiled with flow tracks 70, which are aligned along the direction of rotation of the corresponding gears 12, 16, 18, 20, 22. The flow tracks are distributed at a uniform, axial spacing along the surfaces 36, 38, 40, 42 and have a width of a few, preferably 3-5, millimeters.

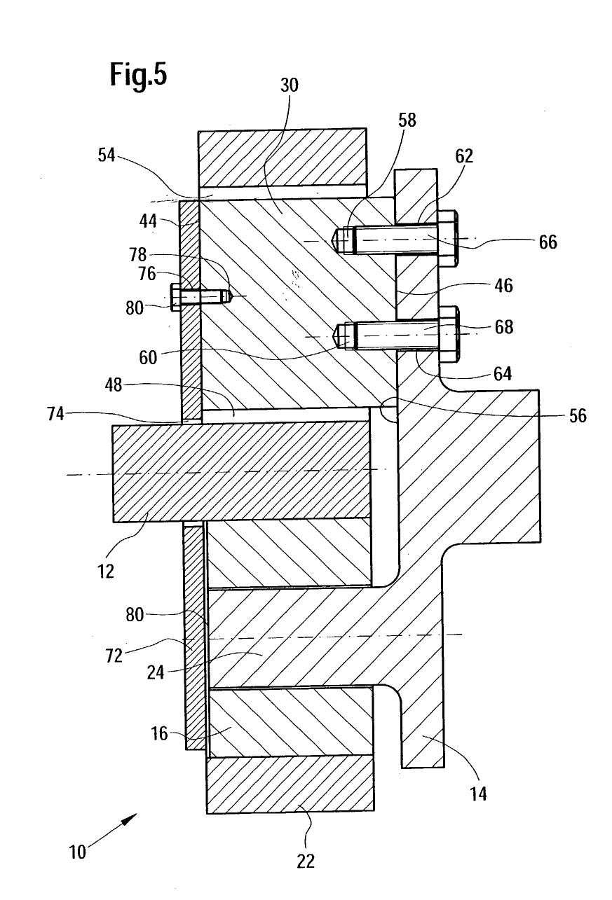

Referring now to FIG. 5. the planetary gear train is also provided with a sealing plate 72. The sealing plate 72 is cylindrical and engages the axial end face 44 of members 30, 32, 34. The sealing plate 72 contains a central hole 74, whose diameter is somewhat larger than the diameter of the sun gear 12, so that the sun gear 12 can project through the hole 74 without engaging sealing plate 72. In the region of the members 30, 32, 34, the sealing plate 72 is provided with through holes 76. Threaded holes 78 are formed in the end surfaces 44 of the members 30, 32, 34 and are aligned with holes 76. The sealing plate 72 is screwed tightly to the members 30, 32, 34 by bolts 80 which are screwed into holes 78. In this alternative embodiment, the members 30, 32, 34 project axially slightly past the ends of the planet gears 16,18, 20, or past the ends of the planet pins 24, 26, 28, so that there is a gap 82 between the connection plate 72 and the planet gears 16,18, 20 or the planet pins 24, 26, 28.

While the present invention has been described in conjunction with a specific embodiment, it is understood that many alternatives, modifications and variations will be apparent to those skilled in the art in light of the foregoing description. For example, the profiling of the cylindrically curved surfaces 36, 38, 40, 42 of the members 30, 32, 34 can also be realized in different ways, such as by applying a flow-optimizing scale pattern or the like. Furthermore, members 30, 32, 34 could be hollow in order to reduce weight. The invention has been described in a single support-frame planet carrier configuration. However, it can also be applied to an assembly equipped with multi support-frame planet carriers, so that the efficiency can also be optimized by reducing the slip loss on the planet gears with multi support-frame planet carriers. Accordingly, this invention is intended to embrace all such alternatives, modifications and variations which fall within the spirit and scope of the appended claims.

We claim:

1. A planetary gear train having a sun gear, a planet carrier, and a plurality of planet gears, each rotatably mounted on a shaft mounted on the planet carrier, characterized by:
a plurality of space filling members, mounted on the planet carrier, the members extending in an axial direction and substantially filling a space between adjacent planet gears and the sun gear, the members being spaced apart from the sun gear and the planet gears.

2. The planetary gear train of claim 1, wherein:
a plurality of gaps are formed between the members and the adjacent gears, said gaps having uniform widths.

3. The planetary gear train of claim 1, wherein:
the members and the planetary carrier are formed in one piece.

4. The planetary gear train of claim 1, wherein:
the members are formed separately and attached to the planet carrier.

5. The planetary gear train of claim 1, wherein:
a sealing plate covers the members and the planet gears, the members being located between the sealing plate and the planet carrier.

6. The planetary gear train of claim 5, wherein:
the sealing plate is formed separately and attached to the members.

7. The planetary gear train of claim 1, wherein:
flow tracks are formed in a surface of the members which faces the gears.

8. The planetary gear train of claim 1, wherein:
the members are hollow.
